(19) United States
(12) Patent Application Publication
(10) Pub. No.: US 2002/0097240 A1
(43) Pub. Date: Jul. 25, 2002

(54) Method and system for deforming a surface web by a sphere in a computer graphics scene

(76) Inventors: Peter Scott, Raleigh, NC (US); Kenneth Hubbell, Raleigh, NC (US); Scott A. Evenson, Pittsboro, NC (US)

Correspondence Address: David L. McCombs, Haynes and Boone, LLP, 901 Main Street, Suite 3100, Dallas, TX, 75202-3789, US

(21) Appl. No.: 09/833,849

(22) Filed: Apr. 12, 2001

Related U.S. Application Data
(60) Provisional application No. 60/200,100, filed on Apr. 27, 2000.

(51) Int. Cl. G06T 17/00

(52) U.S. Cl. 345/423

(57) ABSTRACT

An improved system and method is provided to closely represent visual clues caused by interactions between an object and a surface in a computer graphics scene. The object is attached with at least one invisible graphical item which may be in contact with the surface. The surface is defined by a virtual web of vertices, and one or more vertices are displaced when the sphere contacts the surface. This displacement creates the visual clues as the object moves around the scene in an unpredictable manner.

### CROSS REFERENCE

This application claims the benefits of the provisional application of U.S. patent application Ser. No. 60/200,100 which was filed on Apr. 27, 2000.

### BACKGROUND OF THE INVENTION

The present invention relates generally to data processing for computer graphics, and more particularly, to a system and method for processing three-dimensional computer-based graphics.

A computer-based graphics processing system represents three-dimensional objects and renders them for display on a two-dimensional display device. The system normally includes computers, display devices, and other necessary hardware and software for processing and displaying computer graphics. For example, in many applications, animated scenes are depicted where objects and characters move around within the scene and interact with each other. A character may pick up, put down, or drop an object. Objects such as vehicles may move extensively around the scene as well. A user of a computer system playing or running the scene asserts various degrees of control over some actions of the objects through input devices such as pointers, mice, joy sticks, keyboards, or other similar interactive control devices. For instance, the user may in some cases control where, within the scene, a character moves and which objects are to be picked up or dropped. As the complexity of applications advances, and as more user interactions are involved, more control is vested in the user. As a result, it becomes harder to predict how objects and characters may behave in the scene.

One object for the computer-based graphics processing system is to depict the graphics scene as close as possible to a real-world scene so that the user has a strong feeling of the so called “virtual reality.” In the real world, when objects and characters move, they sometimes leave behind visual clues as a result of their movements. For example, people may leave footprints on a muddy road, and similarly, vehicles may leave tire marks. In reality, when a person sits on a seat cushion or an object is placed thereon, the cushion is likely depressed at the point of contact. In general, objects usually leave dents or craters in surfaces in contact when they are dropped or thrown.

In computer graphics, given the unpredictable nature of the movements of objects or characters in a user-controlled scene, it has been difficult to realistically represent these visual clues. The conventional method may be simply superimposing images of footprints, holes, craters, tire marks, etc., into a scene by trying to predict all possible interactions and then using the best approximation thereof. To superimpose images, the resultant images must be known beforehand or calculated in a real time fashion. This approach may be a workable solution in predictable or controlled cases because it is always possible to know beforehand where alterations to the scene will be made. For instance, if a truck can go only in one lane and the image for the tire marks is determined, as the truck moves, the images of the tire marks can be superimposed on the road. This superimposing approach is unlikely to be a satisfactory solution to be used in a scene where the user has much control of the truck and/or if it may not be known in advance what the tire marks will look like and where they will be placed.

In addition, if the entire scene has to be altered for every instant when the user-controlled object moves, real time or “on the fly” calculations involved in processing the graphics have been proved to be complex and time consuming, thus do not suit the need of various complex graphics applications today.

Therefore, what is needed is a method for closely representing visual clues caused by interactions between objects or between an object and a surface in a computer graphics scene.

### SUMMARY OF THE INVENTION

An improved system and method is provided to closely represent visual clues caused by interactions between objects or between an object and a surface in a computer graphics scene. While creating or programming the graphic scene, each object which may be in contact with any surface in the scene is attached with at least one invisible graphical item. Any surface that may come in contact with the object in the scene is represented by a virtual web of vertices also invisible to the user/viewer of the graphics scene. As a user moves an object in the scene in an unpredictable manner, and when the moved object is in contact with a surface, one or more vertices of the surface are displaced accordingly. This is done mainly by moving any vertices inside the boundaries of the graphical item after the contact is made onto a predetermined surface of the graphical item so that visual effects can be created to represent the visual clues left behind by the movement of the object. The size of the graphical item is determined by many factors including the visual effect expected, the speed of the moving object, etc.

In One example of the present invention, visual clues caused by interactions between an object and a surface in a computer graphics scene, wherein the surface being represented by a virtual web of vertices, are dynamically presented. First, at least one spherical item is attached to the object which is expected to be in contact with the surface, then the object is placed to a predetermined position on the surface for making the contact. In order to attach the spherical item, one or more locations on the object are identified that are expected to have a contact with the surface. The spherical item is positioned as attached to the object. After the spherical item is positioned, one or more vertices are displaced in a predetermined manner. In one example, one or more vertices of the web residing within the boundary of the spherical item are identified due to the contacts made by the spherical item on the surface, and they are relocated onto a predetermined location on the surface of the spherical item. The spherical item and the virtual web of vertices are designed to be invisible to a user viewing the computer graphics scene, and the displaced vertices deform the surface so that the visual clues are depicted.

### BRIEF DESCRIPTION OF THE DRAWINGS

FIG. 1 illustrates a surface in a computer scene represented by a virtual web having an array of vertices.

FIG. 2 illustrates displacement made to one or more vertices of the virtual web of FIG. 1 when a sphere is in contact with the surface.

FIGS. 3a and 3b illustrate one example of the present invention being used to leave a visual clue from a character walking across a surface.

FIG. 4 illustrates a computer system for implementing the present invention.

### DETAILED DESCRIPTION

In a computer graphics scene, various surfaces of objects, such as a road or the seat of a chair, may exist to represent these objects in reality. There are also different kinds of objects controllable or movable by a user. The following disclosure provides different embodiments for the sake of example.

Referring to FIG. 1, a “web” 10 is shown to represent a surface according to one example of the present invention. This web, in general, is an array of points or vertices 12 connected by lines to form a group of panels 14. In this case, the panels are in triangular shape. Each vertex 12 of a panel 14 has three coordinates which are sufficient to represent the vertex in a three dimensional space. A predetermined texture mapping can also be provided so that the panels of the web are given colors, shadings and textures as desired in the scene.

In different embodiments, each panel 14 may be given a different texture or may be uniformly configured. Also, each panel 14 may be of a different size or shape. To simplify the illustration, it is assumed that the vertices of each panel 14 are uniformly spaced in the X- and Y-planes, and they are able to be programmed to move in the Z-plane in order to change the shape of the web. Similarly, it is also assumed in this illustration that a regular spacing of the vertices in the X- and Y-directions is maintained. Hence, each vertex has three coordinate values representing the displacement in the X, the Y, and the Z-direction. The displacements of the vertices help to create different visual effects of the panel surface. For example, a displacement of zero in the Z direction for all the vertices in the web gives the appearance of a flat surface. In order to create the visual effect of a non-flat surface, some of the vertices can be moved. A positive displacement of a vertex in the Z direction gives the appearance of a “bump,” a negative displacement in the Z direction gives the appearance of a “pit.” Therefore, such a web can be very helpful in creating computer graphics that are close to reality because the surfaces can be shaped as needed.

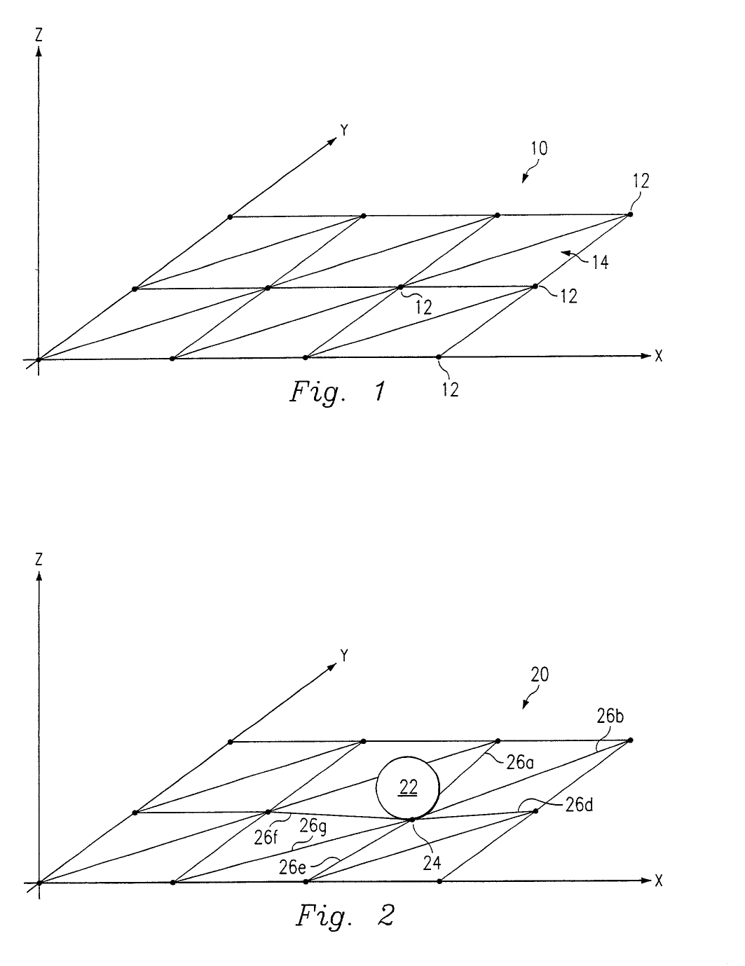

Referring now to FIG. 2, a surface 20 is shown in the web form as described above in connection with FIG. 1 with a sphere 22 coming in direct contact with the web. It is understood that a sphere is just one example of a three dimensional graphical item for performing the functions of the present invention. In order to display a realistic representation of an interaction between objects in the graphics scene (the surface and the sphere in this case), the web is deformed in the following manner. When the sphere 22 is placed on or through the web 20, any vertex of the web which would be otherwise located inside the sphere 22 if the image of the sphere is superimposed on the web is moved onto the surface of the sphere. As shown in FIG. 2, the sphere 22 is assumed to rest on vertex 24, and the sphere 22 has “pushed” the web 20 downward. How much the web is pushed down can be determined by the designer of the scene considering many factors such as how heavy the object is, how fast the object moves, how much is needed to create a discernable visual effect. Due to the presence of the sphere 22, a visual effect is created to place the contact point between the sphere and the web at a point lower than the zero level in the Z direction. In addition, if the sphere 22 moves, other vertices continue to be moved to the bottom or exterior of the sphere 22. In this case, vertex 24 is moved to the bottom of the sphere 22, which “drags” lines 26a-26g connected to vertex 24 downward. In this example, the sphere 22 can be defined as a surface given by a center of (X, Y, Z) and a radius “R”. In the coordinate system of the web as shown in FIG. 1 or 2, the sphere may be represented as a collection of points (a, b, c) in the three-dimensional space wherein a, b and c bear the relation among them as represented by the following equation:

(X-a)²+(Y-b)²+(Z-c)²=R² (1)

Given a set of coordinates (x, y, z) representing a vertex of the web, it can be readily determined whether each vertex of the web is inside or outside the sphere. In a very simple example, the distance between the center of the sphere and the affected vertex is calculated. If this calculated distance is shorter than the radius of the sphere, the vertex is considered “inside” the sphere, and is to be moved onto the sphere. It is understood that if a non-spherical graphical object is used for deforming the web, an appropriate method can be used for determining what is considered to be “inside.” For each vertex resting inside the sphere 22, a new value of Z coordinate is calculated using equation (1) assuming the X and Y coordinates remain the same. As such, the new coordinates of the vertex is obtained and in effect, and the vertex becomes a point on the sphere. For a more complex case such as a moving object, e.g., a “falling sphere,” the center coordinates (X, Y, Z) changes over time, but at each predetermined moment, the above described method still applies, and any points found inside the falling sphere will be constantly displaced to the surface of the sphere.

In the graphics scene, as it is well known, each object is defined as a collection of geometric shapes: lines, arcs, surfaces, etc. A character may have a whole geometry for the arms, legs, head, etc. The shape, color, texture, and visibility of each object is calculated and reconfigured as the object moves. With the understanding of the method described above for depicting an interaction between an object and a surface, when designing objects or characters, a designer of the scene programs in an object's geometry invisible or transparent spheres at points where the object does or could interact with other objects or surfaces in the scene. For example, a truck can be designed with invisible spheres on its tires, and since the locations of the spheres in the scene change continuously, marks will be made on a road as it drives through. Data processing involved in determining the locations of these spheres are carried out in each instant, but can be limited to processing moving spheres only. The advantage of the method as described above in this particular case is that the image of the tire marks does not need to be known beforehand, and the tire marks are not simply superimposed on the image of the road that the truck is traveling on. Instead, the road surface is deformed as the truck moves to show the unpredictable marks left by the truck tires.

In general, the result of constantly relocating spheres is that unpredictable alterations to surfaces in a graphic scene is effected as induced by interactions by the computer system user. The following are a few examples that may further explain the applications of the present invention.

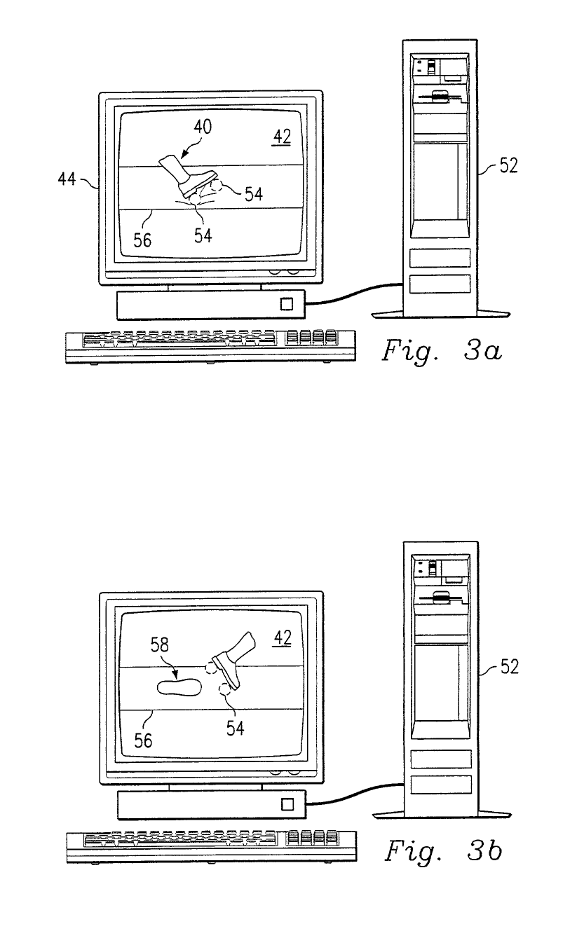

Referring to FIGS. 3a and 3b, in one example, footprints of characters in a scene can be produced by using the above-described method. FIG. 3a illustrates a character 40 moving through the scene 42 shown on a display device 44 in response to commands from the user using an interactive control device such as the keyboard, a mouse, a joystick, or any other similar devices (generally a computer 52). By placing small transparent spheres 54 on the bottom of the character's feet, the web on a surface 56 (e.g., a dirt road) will be deformed as the character 40 walks through the scene. FIG. 3b illustrates a visual clue 58 left by the character's foot, using the spheres 54 of FIG. 3a.

In another example, by placing spheres on the “body” of a character in the scene, as the character sits on any furniture, the web which constitutes the furniture surface will be deformed. In this case, the deformation is shown as temporary. As the character stands up again, the web is returned to its original state. This is typically accomplished by introducing nonvisible residual spheres which change their shapes over time. For example, as the character sits down, the cushion is deformed by spheres attached to the character's body. As the character stands, copies of these spheres remain in place and over time, change in either position or size, or both. The effect is that the cushion appears to regain its original shape over time as the deformation of the cushions is removed while the spheres are changing their shapes and sizes (e.g., shrinking in size). The speed of change made to the shape or size of any one sphere is programmable and therefore the “recovering process” of the surface such as the cushion is fully controllable.

In another example, a sphere can be attached to a falling object to create visual clues caused by the falling object. The size of the sphere is determined as a function of the speed of the falling object. As the object falls, the sphere would create a crater. In this case, the center of the sphere is not necessarily the center of the object. The sphere would be positioned so that the surface of the sphere coincides with the surface of the object as it “hits” a surface web. In this example, a “pit” or other indentations may be left. For example, if the object bounces after it hits, the impact may leave a mark where the object lands each time as it strikes the ground. This is accomplished by having copies of the deforming spheres remain in place, though not visible, after the object bounces. These residual spheres would not change in location or size resulting in pits or indentations which do not change over time.

In yet another example, spheres can be attached to digging instruments, such as shovels, rakes, hoes, large earth-moving machines, steam shovels, or back hoes. As the user operates these instruments, the surface web is deformed to show holes or trenches. Moreover, it is important to note that although a sphere is used above for the invisible three dimensional graphical item, all other three dimensional objects suitable for the same purpose can be used too. It is usually the graphical designer who determines the object and its corresponding characteristics such as the size.

The following are sample pseudo codes for programming a sphere and a surface web to create visual effects as described in various examples above.

In the program, it is assumed that for a single fixed-size moving sphere with a fixed web, each point/vertex in the web is represented as:

W(i), where i=1 to n*m (an array of “n” by “m” points) (2)

and the center of the sphere is determined as a function of time, S(t). The radius of the sphere is R, and the general representation of the sphere in a three dimensional space is:

X²+Y²+Z²=R² (3)

Hence, the pseudo code is as follows:

for t=1 to T

for i=1 to n*m

| | |
|---|---|
| d = distance(W(i),S(t)); | /*calculate distance between W(i) and |

sphere center*/

| | |
|---|---|
| if d<R then | /*web point inside sphere */ |

| newZ=sqrt(R²−x²−y²) /*calculate new Z value */ | |
|---|---|
| W(i)=point(x,y,newZ) | /*displace point to surface of the |

sphere*/

endif

end

end

In case the size of the sphere is a variable, but with a fixed web, it is still assumed that each point/vertex in the web is represented as:

W(i), where i=1 to n*m (an array of “n” by “m” points) (4)

and the center of the sphere is determined as a function of time, S(t). The radius of the sphere is R(t), and the general representation of the sphere in a three dimensional space is:

X²+Y²+Z²=R(t)² (5)

and the pseudo code for this example is as follows:

for t=1 to T

for i=1 to n*m

| | |
|---|---|
| d = distance(W(i),S(t)); | /*calculate distance between W(i) and |

sphere

center*/

| | |
|---|---|
| if d<R then | /*web point inside sphere*/ |

| | |
|---|---|
| newZ=sqrt(R(t)²−x²−y²) | /*calculate new Z value*/ |

| | |
|---|---|
| W(i)=point(x,y,newZ) | /*displace point to surface of the |

sphere*/

endif

end

end

In the case of having multiple variable-sized moving spheres with a fixed web, it is assumed that each point/vertex in the web is represented as

W(i), where i=1 to n*m (an array of “n” by “m” points) (6)

and the center of the sphere is determined as a function of time, S(s, t), for spheres 1 through s. The radius of the sphere is R(s, t), and the general representation of the sphere in a three dimensional space is:

X²+Y²+Z²=R(s, t)² (7)

and the following is the pseudo code for this case:

for t=1 to T

for i=1 to n*m

| | |
|---|---|
| for j=1 to s | /*for each sphere*/ |

| | |
|---|---|
| d = distance(W(i),S(j,t)); | /*calculate distance between W(i) and |

j−th

sphere center*/

| | |
|---|---|
| if d<R then | /*web point inside sphere*/ |

| newZ=sqrt(R(j,t)²−x²−y²) /*calculate new Z value*/ | |
|---|---|
| W(i)=point(x,y,newZ) | /*displace point to surface of the |

sphere*/

endif

end

end

end

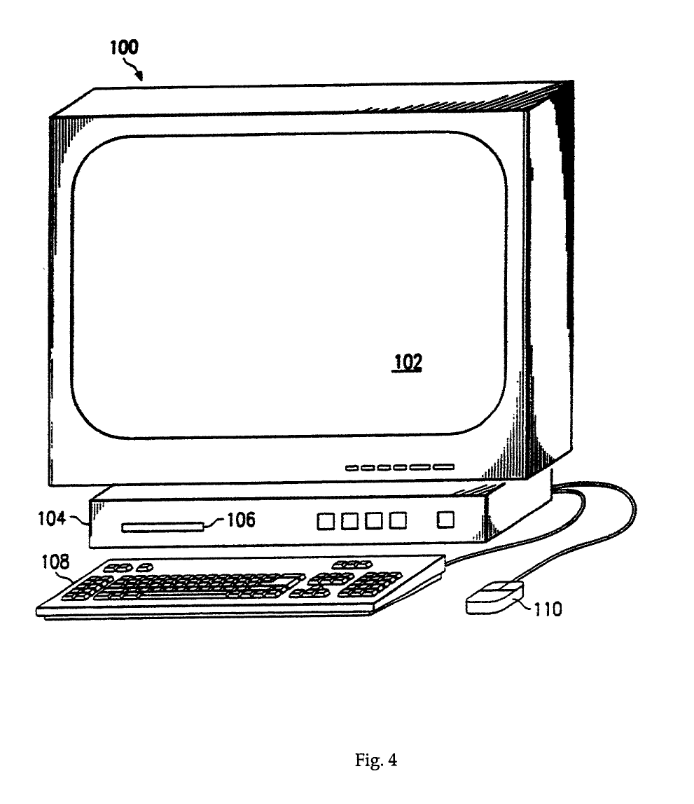

Referring now to FIG. 4, a computer system 100 includes a two-dimensional graphical display (also referred to as a “screen”) 102 and a central processing unit 104. The central processing unit 104 contains a microprocessor and random access memory for storing programs. A disk drive 106 for loading programs may also be provided. A keyboard 108 having a plurality of keys thereon is connected to the central processing unit 104, and a pointing device such as a mouse 110 is also connected to the central processing unit 104. It will also be understood by those having skill in the art that one or more (including all) of the elements/steps of the present invention may be implemented using software executed on a general purpose computer system or networked computer systems, using special purpose hardware-based computer systems, or using combinations of special purpose hardware and software.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for representing visual clues caused by interactions between a first object and a second object in a computer graphics scene, the second object having a surface represented by a virtual web of vertices, the method comprising:
attaching at least one three dimensional graphical item to the first object which is expected to be in contact with the surface of the second object;
displacing one or more vertices when the graphical item contacts the surface of the second object,
wherein the graphical item and the virtual web of vertices are invisible to a user viewing the computer graphics scene, and wherein the displaced vertices deform the surface for depicting the visual clues resulting from the contact between the first and second objects.

2. The method of claim 1 wherein the step of attaching further includes:
identifying one or more locations on the first object that are expected to have a contact with the surface of the second object; and
attaching the graphical item to the identified locations.

3. The method of claim 1 wherein the graphical item is of a predetermined geometrical shape having a predetermined geometrical size.

4. The method of claim 1 wherein the graphical item is a spherical object of a predetermined size.

5. The method of claim 1 wherein the step of displacing further includes:
placing the first object to a predetermined position on the surface of the second object for making the contact;
positioning the graphical item as attached to the first object;
identifying one or more vertices of the web residing within boundaries of the graphical item due to the contacts made by the graphical item on the surface; and
relocating the identified vertices onto a predetermined surface of the graphical item.

6. The method of claim 5 wherein the step of identifying further includes:
calculating the distance between the center of the graphical item to the vertices within the boundaries of the graphical item; and
identifying the vertices which have the calculated distance shorter than a predetermined value so as to recognize the vertices as within the boundaries of the graphical item.

7. The method of claim 1 further comprising having the displaced vertices recover from the displacement by using at least one copy of the graphical item after the first object ceases to contact with the second object.

8. The method of claim 7 wherein the shape of the copy of the graphical item changes over time in a programmable manner.

9. The method of claim 7 wherein the size of the copy of the graphical item changes over time in a programmable manner.

10. The method of claim 1 further comprising leaving at least one copy of the graphical item remain permanently to reserve the displacement of the vertices.

11. A method for representing visual clues caused by interactions between an object and a surface in a computer graphics scene, the surface being represented by a virtual web of vertices, the method comprising:
attaching at least one spherical item to the object which is expected to be in contact with the surface;
placing the object to a predetermined position on the surface for making the contact;
positioning the spherical item as attached to the object;
displacing one or more vertices when the spherical item contacts the surface,
wherein the spherical item and the virtual web of vertices are invisible to a user viewing the computer graphics scene, and wherein the displaced vertices deform the surface for depicting the visual clues resulting from the contact between the surface and the object.

12. The method of claim 11 wherein the step of attaching further includes:
identifying one or more locations on the object that are expected to have a contact with the surface; and
attaching the spherical item to the identified locations.

13. The method of claim 11 wherein the step of displacing further includes:
identifying one or more vertices of the web residing within the boundary of the spherical item due to the contacts made by the spherical item on the surface; and
relocating the identified vertices onto a predetermined location on the surface of the spherical item.

14. The method of claim 13 wherein the step of identifying further includes:
calculating the distance between the center of the spherical item to the vertices within the boundary of the spherical item; and
identifying the vertices which have the calculated distance shorter than a radius of the spherical item so as to recognize the vertices as within the boundary of the spherical item.

15. The method of claim 11 further comprising having the displaced vertices recover from the displacement by using at least one copy of the spherical item after the object ceases to contact with the surface.

16. The method of claim 15 wherein the shape of the copy of the spherical item changes over time in a programmable manner.

17. The method of claim 15 wherein the size of the copy of the spherical item changes over time in a programmable manner.

18. The method of claim 11 wherein at least one copy of the spherical item remain permanently to reserve the displacement of the vertices.

19. A computer program for representing visual clues caused by interactions between an object and a surface in a computer graphics scene, the surface being represented by a virtual web of vertices, the program comprising instructions for:
attaching at least one three dimensional graphical item to the object which is expected to be in contact with the surface;
displacing one or more vertices when the graphical item contacts the surface,
wherein the graphical item and the virtual web of vertices are invisible to a user viewing the computer graphics scene, and wherein the displaced vertices deform the surface for depicting the visual clues resulting from the contact between the surface and the object.

20. The computer program of claim 19 wherein the instructions for attaching further includes instructions for:
identifying one or more locations on the object that are expected to have a contact with the surface; and
attaching the graphical item to the identified locations.

21. The computer program of claim 19 wherein the graphical item is of a predetermined geometrical shape having a predetermined geometrical size.

22. The computer program of claim 19 wherein the graphical item is a spherical object of a predetermined size.

23. The computer program of claim 19 wherein the instructions for displacing further includes instructions for:
placing the object to a predetermined position on the surface for making the contact;
locating the graphical item as attached to the object;
identifying one or more vertices of the web residing within boundaries of the graphical item due to the contacts made by the graphical item on the surface; and
relocating the identified vertices onto a predetermined surface of the graphical item.

24. The computer program of claim 23 wherein the instructions for identifying further includes instructions for:
calculating the distance between the center of the graphical item to the vertices within the boundaries of the graphical item; and
identifying the vertices which have the calculated distance shorter than a predetermined value so as to recognize the vertices as within the boundaries of the graphical item.

25. A system for representing visual clues caused by interactions between an object and a surface in a computer graphics scene, the surface being represented by a virtual web of vertices, the system comprising:
means for attaching at least one spherical item to the object which is expected to be in contact with the surface;
means for placing the object to a predetermined position on the surface for making the contact;
means for positioning the spherical item as attached to the object; and
means for displacing one or more vertices when the spherical item contacts the surface,
wherein the spherical item and the virtual web of vertices are invisible to a user viewing the computer graphics scene, and wherein the displaced vertices deform the surface for depicting the visual clues resulting from the contact between the surface and the object.

26. The system of claim 25 wherein the means for attaching further includes:
means for identifying one or more locations on the object that are expected to have a contact with the surface; and
means for attaching the spherical item to the identified locations.

27. The system of claim 25 wherein the mean for displacing further includes:
means for identifying one or more vertices of the web residing within the boundary of the spherical item due to the contacts made by the spherical item on the surface; and
means for relocating the identified vertices onto a predetermined location on the surface of the spherical item.

28. The system of claim 27 wherein the means for identifying further includes:
means for calculating the distance between the center of the spherical item to the vertices within the boundary of the spherical item; and
means for identifying the vertices which have the calculated distance shorter than a radius of the spherical item so as to recognize the vertices as within the boundary of the spherical item.
